(19) United States
(12) Patent Application Publication
(10) Pub. No.: US 2006/0129453 A1
(43) Pub. Date: Jun. 15, 2006

(54) System and method for display advertising

(76) Inventors: Michelle L. Gardner, Oak Park, CA (US); Shayne G. Mihalka, Ventura, CA (US); David Gross, Ventura, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/013,297

(22) Filed: Dec. 15, 2004

(51) Int. Cl. G06Q 30/00

(52) U.S. Cl. 705/14

(57) ABSTRACT

A technique for display advertising on Internet “Web” pages is disclosed. The technique is used by an advertising intermediary that matches available advertising inventory from a network of publishers with the needs of advertisers who engage in advertising campaigns. The advertising intermediary sets a range of prices it will pay the publishers for placing advertisements for an advertising campaign, and sets an initial price within this range which is paid to all publishers carrying the advertisement. After the advertising campaign has proceeded to a first measuring point, the performance of the advertising is assessed, the price is adjusted within the initial price range to reflect the performance, and all publishers carrying the advertisement are then paid this adjusted price. Thereafter, when the advertising campaign has proceeded to a second measuring point, a second price adjustment is made based on the performance, with the price remaining the in the initial range. Preferably, the second price adjustment is made on a publisher-by-publisher basis based on the performance of the advertisement on web sites.

### BACKGROUND OF THE INVENTION

1. Field of the Invention

The present invention relates to methods of Internet advertising and is specifically directed to a system and method for improving the utilization of available display advertising inventory.

2. Background

Computer networks, particularly the Internet, provide an increasingly important medium for advertising all types of goods and services. Currently, the Internet extends to millions of computers in more than one hundred countries. The Internet comprises the World Wide Web (the “Web”), whereby a huge number of “web servers” connected to the Internet disseminate via “web pages” various types of information or content, including text, graphics, and media (video and audio) files. Typically, web pages are viewed on computers using “web browser” software, such as the “Internet Explorer” distributed by Microsoft Corp. However, web pages may also be accessed by other devices, such as personal digital assistants (“PDAs”), mobile phones, etc.

Various technological developments have given rise to tremendous growth in use of the Internet generally, and the Web in particular. These developments include the increased availability of both commercial and residential high-speed Internet connections, improvements in the capabilities of browser and server software, improvements in search services that allow users to quickly identify sources of useful information, and the dramatic increase in the amount of information that is available. The broad acceptance of the Web as a tool for research, communication, recreation, and commerce has attracted vast numbers of users, such that nearly all businesses have some type of “presence” on the Web. As businesses have embraced the Web as a tool for selling products, the capability to provide secure payment and ordering systems has also been developed. As a result, a large and vibrant Web-based marketplace has emerged.

The unique features of the Web provide a platform for a variety of different forms of advertising. The most common form of advertising on the Web uses display advertisements, which are similar to traditional advertising seen in print media and on television. Publishers of web sites sell space for display advertisements of various configurations, such as “banner” and “sidebar” advertisements of various shapes and sizes.

The ability of web browsers to open multiple display windows on a computer screen has also led to the creation of variations, such as “pop-up” and “pop-under” advertisements that open in a new window either on top of or underneath the window displaying the web page itself. New types of display advertisements are constantly being developed and tested. Display advertisements usually include a “link” to the web site of the advertiser, such that the advertiser's site can be easily accessed by “clicking” on the link.

A variety of techniques have been developed to match advertisers seeking to place display advertisements with publishers who have inventory available for the display of advertisements. Such techniques often rely on third-party intermediaries to match Web publishers with Web advertisers. Third-party intermediaries play an increasingly important role in Web advertising, as described in greater detail below. Such intermediaries can buy advertising space on a wholesale basis, and provide unique experience and services to advertisers and web publishers alike. Often the third-party intermediary will contract with a number of publishers to fill advertising inventory, and those publishers can be viewed as a network. The current invention is primarily concerned with advertising campaigns that use a third-party intermediary, sometimes referred to herein as an advertising network. Accordingly, the following description is presented with the idea that a third-party intermediary is involved.

Advertisers typically develop specific advertising campaigns that are often set in duration or are limited by a predetermined budget. Such advertising campaigns may be developed and implemented for various reasons, including, for example, to promote a new product or service, a special offer or sale, or simply to periodically provide visibility for existing products or services. Currently, advertisers and advertising networks typically set a fixed price that will be paid to a publisher for advertising inventory used on a particular advertising campaign.

The effectiveness of advertising is of paramount importance to both advertisers and advertising networks. If a publisher's web site is not performing adequately to support the price being paid on a particular campaign, it will be “turned off” such that it no longer receives advertisements for that campaign. This may be detrimental to both the publisher and the advertiser. The publisher is left with unused or remnant advertising inventory, and the advertiser has lost the opportunity to have its advertisements displayed to consumers visiting that site.

### SUMMARY OF INVENTION

The present invention is directed to systems and methods for display advertising that allow web site publishers to fill more of their available inventory and increase their overall revenue.

In one embodiment, the present invention allows publishers to elect to display advertisements at any price that falls within a set range of prices, where the actual price paid to that publisher is based on the performance of the publisher's web site.

It is an object of the present invention to provide a method and system that gives publishers greater flexibility and control in determining the price or range of prices they will accept for their advertising inventory.

It is a further object of the present invention to provide advertising networks with improved ability to manage pricing of their available display advertising inventory.

It is a further object of the present invention to provide advertisers with increased reach for their performance-based advertising campaigns by making available advertising inventory that would be otherwise unavailable to that advertiser.

### BRIEF DESCRIPTION OF THE DRAWINGS

FIG. 1 is diagram illustrating the layout of a typical web page with display advertisements.

FIG. 2 is a diagram illustrating the basic elements of an advertising network.

FIG. 3 is a flow chart illustrating a preferred embodiment of the invention.

### DETAILED DESCRIPTION OF THE PREFERRED EMBODIMENTS

The current invention is directed to methods and systems for improved management of display advertising inventory. Descriptions of specific embodiments or applications are provided for exemplary purposes, various modifications to the described embodiments will be apparent to those skilled in the art, and general principles defined herein may be applied to other embodiments and applications without departing from the spirit and scope of the invention. Thus, the present invention is not intended to be limited to the embodiments shown, but is to be accorded the widest scope consistent with the principles and features disclosed herein.

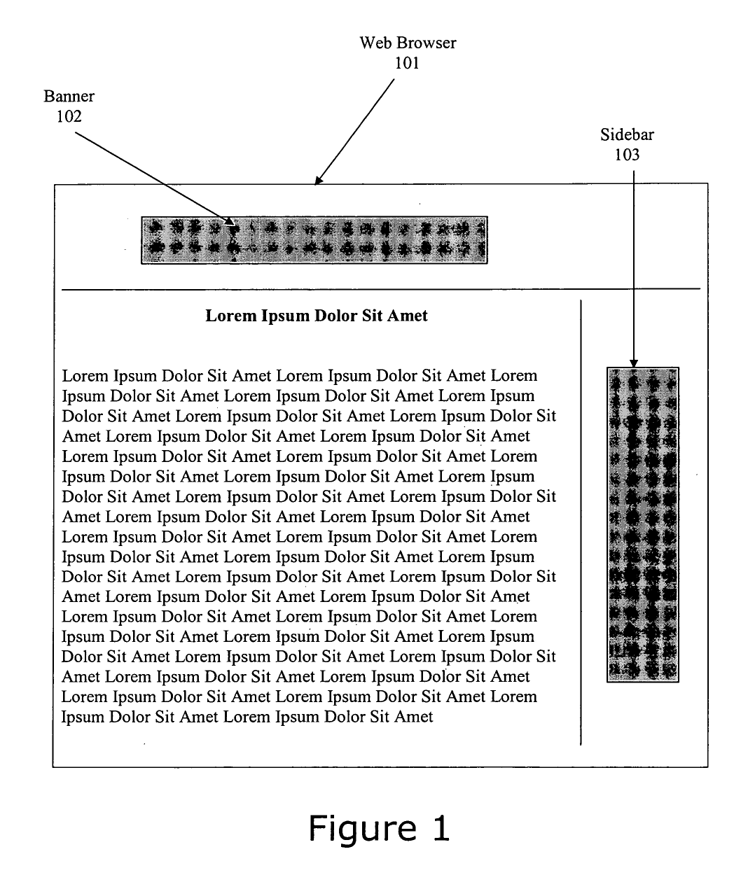

Many web site publishers generate substantial revenue by making a certain amount of space on their web pages available for use to display advertisements to individuals who “visit” their web sites. Indeed, some widely used web sites generate most or all of their income in this manner. The amount of space available on a web page can be thought of as a form of advertising inventory. FIG. 1 illustrates two typical types of display advertisements commonly referred to as banner 102 and sidebar 103 advertisements.

Web publishers commonly sell their available display advertising inventory based on a cost-per-thousand impressions, commonly referred to as CPM, where each “impression” comprises a visit to their web site or a “page view.” Thus, the CPM is the price that the publisher charges to display a particular advertisement a thousand times, i.e., to provide a thousand impressions.

The inventory of available advertising space on any given web site is a function of the amount of display advertising space that the publisher makes available on each page, and the number of “page views” that the web site generates. Thus, the inventory available on a particular site expands and contracts as site traffic increases and decreases. The price that a particular publisher commands for display advertising inventory depends on a variety of factors, including, without limitation: 1) the content of the web site; 2) the demographics of visitors to the web site; 3) the size of the advertisement; 4) the location of the advertisement on a page; 5) the specific pages on which the advertisement will appear; and 6) the type of advertisement (i.e. banner, pop-up, pop-under, etc.).

In order to maximize advertising revenue, publishers attempt to find advertisers that are willing to pay the highest price for the publisher's available inventory. Likewise, in order to maximize the effectiveness of their advertising campaigns, advertisers attempt to find publishers that will enable them to meet their campaign goals with maximum efficiency. Given the burgeoning number of Internet advertisers and web sites, it is challenging for both publishers and advertisers to meet these objectives.

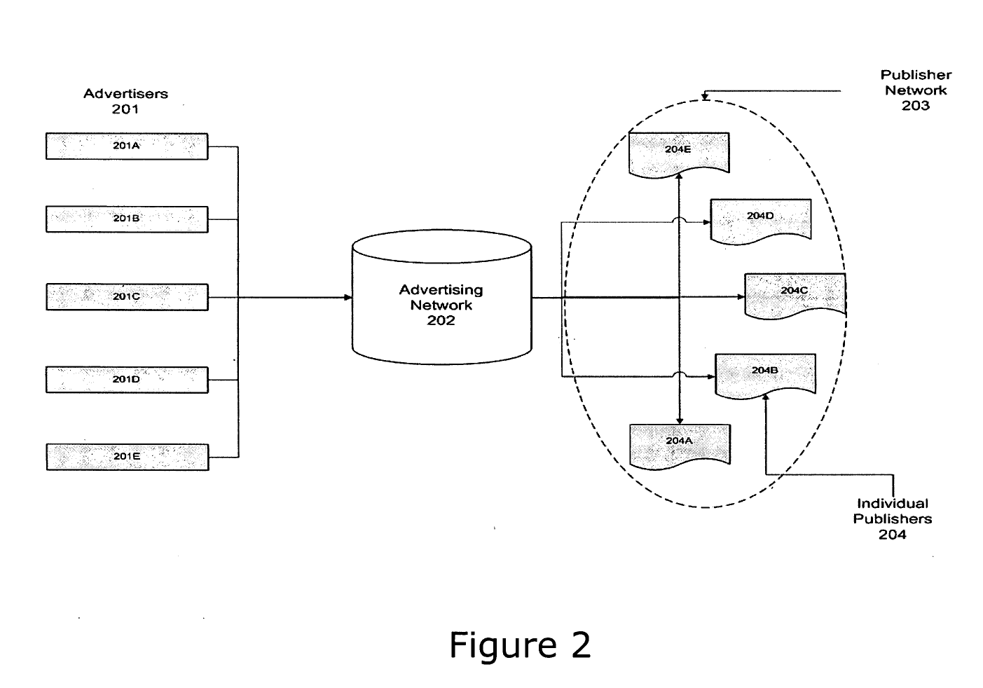

As noted, many publishers use third-party intermediaries or advertising networks to fill their inventory and handle such other tasks as scheduling and delivery of advertisements. The third-party intermediary may be used to fill all or some of a publisher's available inventory. Normally, advertising networks work with multiple advertisers and multiple publishers. FIG. 2 illustrates a typical advertising network relationship.

Some third-party advertising intermediaries allow publishers to set a fixed price for their inventory, while others use a bidding system that sets a price for a particular publisher's inventory. In such systems, the advertising network sets the price it will pay for advertising inventory based on market demand by matching advertisers willing to bid the highest price for advertising space that meets their campaign objectives with publishers that can supply that space.

In order to provide advertising that is more performance-related, some third-party intermediaries allow advertisers to purchase advertising inventory on a performance basis rather than CPM. For example, an advertiser may purchase advertising inventory on a cost-per-action basis where the advertiser only pays for those advertisements that generate a specified consumer action or response. Most commonly the action triggering payment is a “click” and, in such cases this basis may be referred to as “cost-per-click.” If advertising inventory is purchased on a cost-per-action basis, the advertiser only pays when the advertisement results in the viewer taking the desired action, i.e., when the consumer actually clicks on the link in the advertisement taking the consumer to the advertiser's designated landing page. Advertising sold on a cost-per-action basis can be tied to almost any desired action or response that can be tracked.

Advertising that is purchased based on a cost-per-action, or similar basis, is generally referred to as performance-based advertising. In performance-based advertising, payment is conditioned on some measure of the effectiveness of the advertisement in obtaining a particular result, rather than simply on the number of times it is displayed. If a third-party intermediary sells advertising inventory to advertisers and buys advertising inventory from publishers on the same basis; it can simply set a fixed margin to generate revenue. The present invention is concerned, however, with situations where the intermediary buys advertising inventory from publishers on one basis and sells it to advertisers on a different basis.

For example, the intermediary may buy advertising inventory for a performance-based advertising campaign on a non-performance basis such as CPM. In such cases, the intermediary must estimate the expected performance of the advertisements in the campaign and arbitrage the available advertising inventory to make a profit. Any advertising campaign wherein the advertising network sells advertising inventory on one basis and buys advertising inventory on a different basis will be referred to herein as an arbitrage campaign.

In known arbitrage campaigns, as described above, the intermediary sets an initial price that it will pay to participating publishers. In known systems, this initial price is set manually based on the anticipated performance of the campaign across the available advertising inventory. In known systems, this initial price is uniform across all publishers included in the network.

Once the campaign is active, the intermediary may monitor performance of the campaign across all publishers and adjust the price it will pay for advertising inventory in order to maintain profitability. Currently, the adjusted price is offered to all publishers and is not based on site-specific performance. As a result, the advertising network must monitor the performance of advertisements placed on individual sites, and manage the campaign as a whole to assure that it is achieving an adequate margin across all active publisher sites to support the price it is paying to those publishers. If a particular site is not performing adequately, i.e., it is not delivering an adequate number of the desired consumer responses per thousand impressions to support the price paid by the advertiser, it is turned off and receives no further advertisements from that campaign.

Thus, in known arbitrage campaigns, all of the publishers are given a fixed price for advertisements in that advertising campaign. If a publisher's web site does not perform well enough to support that price it will be turned off by the intermediary, such that the publisher may be left with unfilled inventory, and the advertiser will not get the use of the web site.

The present invention addresses this problem by providing publishers with advertising campaigns wherein the price paid for advertising inventory may float depending on performance, preferably within a set range. In the preferred embodiment, publishers that agree to accept advertisements from such an advertising campaign receive a price that is more closely based on the market value of their inventory.

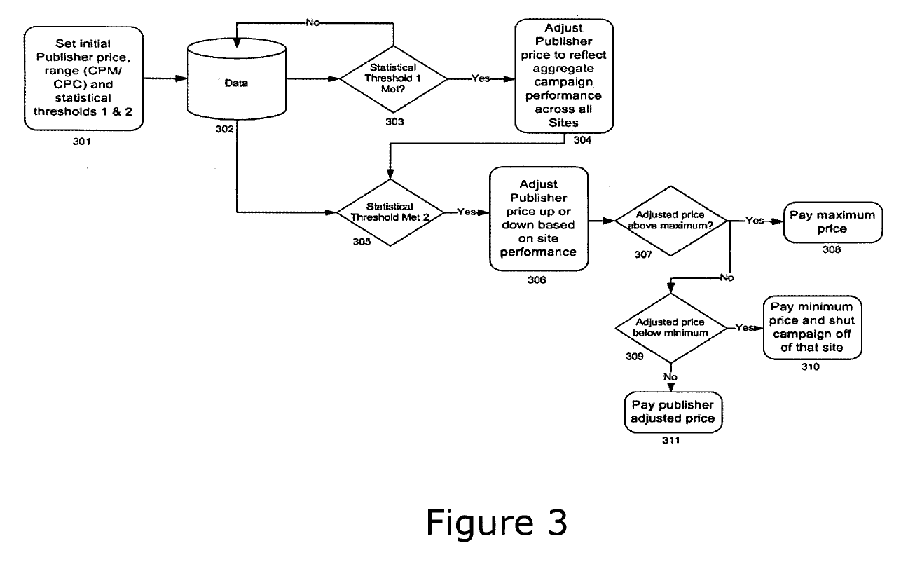

In one preferred embodiment, illustrated in FIG. 3, the third-party intermediary or advertising network sets up a performance-based advertising campaign with an advertiser. Such a campaign may be paid for by the advertiser on any performance-based metric, preferably cost-per-action and most commonly cost-per-click. According to the preferred embodiment, one or more measuring points 303, 305 are set either at the commencement of the campaign, or at some time thereafter. The measuring points, which may be based on statistical thresholds, are preferably set at points where the campaign is expected to be sufficiently mature to allow valid campaign performance assessment. The statistical threshold used for a measuring point may be based on a measurable event, or combination of events, such as the amount of time the campaign has been active, the number of impressions that have been displayed, a fixed percentage of the advertising campaign budget, etc.

In the preferred embodiment, an initial price range for advertising is set 301 prior to the outset of the campaign. Preferably, the range is in CPM, and is applicable to all publishers. Also at the outset of the campaign, a specific CPM is set within this range that is the initial price to be paid to all participating publishers. Participating publishers agree to accept both the initial CPM-based price, and any subsequent adjustment within the specified range, as described below. Thus, in the preferred embodiment the intermediary discloses both the initial price and the range to potential publishers.

In the preferred embodiment, when the advertising campaign has been active for a sufficient amount of time to reach the initial measuring point 303, the intermediary assesses the performance of the campaign in the aggregate across all active publisher sites. Preferably, this assessment is automated. However, it is within the scope of the present invention to perform the assessment manually or using a combination of manual and automated techniques. In addition, it is within the scope of the invention to perform this assessment using less than all active publishing sites, so long as a statistically valid sample is used for the measurement. Based on the overall performance of the campaign, the advertising network adjusts the actual price paid to participating publishers 304. Again, preferably, this adjustment is implemented on an automated basis. In accordance with one embodiment of the invention, at the conclusion of this first adjustment (after the first measuring point), the same adjusted price is paid to all publishers for the campaign. The adjusted price is preferably set to fall within the range set at the outset of the campaign.

Once the advertising campaign reaches a second (or any subsequent) measuring point 305, the intermediary assesses the performance of the campaign on a site-specific basis. The intermediary then adjusts the price that will be paid to each individual publisher web site to reflect the performance of the campaign on that particular site 306. In one embodiment, the price revisions made after the second (or subsequent) adjustment are site specific and are related to the performance of the specific site. Preferably, site-specific price adjustments are made for all of the active sites at substantially the same time. However, it is within the scope of the present invention to make adjustments for less than all of the active sites. For example, in a less preferred embodiment, a subset of sites may be adjusted at one time; a second subset may be adjusted at a later time, etc. The subsets may reflect prioritization; for example, adjustments may be made first to a select group of sites with the highest volume of traffic.

If the adjusted price for a site is within the range set for the campaign, the publisher is thereafter paid the adjusted price until the next adjustment or until the conclusion of the campaign 311. This price most closely reflects the performance of its site and, therefore, the value to the advertiser. If the adjusted price falls below the range set for that campaign 309, the site is preferably inactivated for that campaign and will no longer receive advertisements 310. Alternatively, the publisher may continue to be paid the minimum of the specified range. This alternative, although less preferred, provides incentive to publishers to accept a broad range. If the adjusted price falls above the range set for that campaign 307, the publisher will be paid the maximum price for the range 308.

While in the preferred embodiment, any price adjustments are prospective only; in an alternative embodiment, price adjustments can be applied retroactively.

It will be apparent to those skilled in the art that this invention is not limited to a specific pricing arrangement such as CPM-based pricing. This invention can be applied in any situation where advertising is purchased on one pricing basis and sold on a different pricing basis.

For example, in another preferred embodiment, the advertising intermediary sells advertising inventory to its advertisers on a cost-per-action basis, and purchases advertising inventory from publishers on a cost-per-click basis. The advertising network initially sets a range for the price it will pay publishers on a cost-per-click basis, and an initial price in terms of cost-per-click. Once the campaign has reached an initial statistical threshold, the initial price for all publishers may be adjusted based on aggregate performance of the campaign across all active publisher web sites. Once the campaign has reached a second statistical threshold, the price for each particular publisher web site is adjusted based on the performance of that particular web site. If this site-specific price is within the range set by the advertising network, the publisher is paid that price. If this site-specific price falls below the range set by the advertising network, that web site is inactivated for that campaign. If the site-specific price falls above the range for that campaign, the publisher will be paid the maximum cost-per-click for the range set for that campaign.

It will be apparent to those skilled in the art that the present invention is not limited by the use of statistical thresholds to trigger the application of a site-specific price for advertising inventory. It will be further apparent to those skilled in the art that the present invention is not limited to advertising on the Internet or the Web, but rather can be applied to any interactive advertising environment that can support performance-based advertising. Examples of such environments include, but are not limited to, interactive television, interactive radio, interactive telephone networks, interactive point-of-purchase systems, or any other interactive environment.

What is claimed is:

1. A method of advertising in an interactive environment, comprising:
setting a first price that will be charged to advertisers for placing advertisements;
setting a range of prices that may be paid to publishers for displaying said advertisements, wherein said range of prices is set according to a different basis than said first price;
setting a second price on the same basis of said range of prices, that will be paid to the publisher of each participating source of advertising inventory, wherein said second price is based on the performance of said participating source of advertising inventory.

2. The method of claim 1, wherein said source of advertising inventory is a web site.

3. The method of claim 1, wherein said first price is set as a cost-per-click.

4. The method of claim 1, wherein said first price is set as a cost-per-action.

5. The method of claim 1, wherein said range of prices is set as a cost-per-thousand impressions.

6. A system for advertising in an interactive environment, comprising:
setting a first price that will be charged to advertisers for placing advertisements;
setting a range of prices that may be paid to publishers for displaying said advertisements, wherein said range of prices is set according to a different basis than said first price;
setting a second price on the same basis of said range of prices that will be paid to the publisher of each participating source of advertising inventory, wherein said second price is based on the performance of said participating source of advertising inventory.

7. The system of claim 6, wherein said source of advertising inventory is a web site.

8. The system of claim 6, wherein said first price is set as a cost-per-click.

9. The system of claim 6, wherein said first price is set as a cost-per-action.

10. The system of claim 6, wherein said range of prices is set as a cost-per-thousand impressions.
